(19) United States
(12) Patent Application Publication
(10) Pub. No.: US 2004/0028170 A1
(43) Pub. Date: Feb. 12, 2004

(54) Installation for storing irradiated fuel or radioactive materials

(76) Inventor: Francois De Crecy, Seyssins (FR)

Correspondence Address: Thelen Reid & Priest, P O Box 640640, San Jose, CA, 95164-0640, US

(21) Appl. No.: 10/380,721

(22) PCT Filed: Sep. 14, 2001
(86) PCT No.: PCT/FR01/02864

(30) Foreign Application Priority Data
Sep. 15, 2000 (FR) 0011789

(51) Int. Cl. G21C 19/00

(52) U.S. Cl. 376/272

(57) ABSTRACT

The invention relates to a storage installation for irradiated fuel or radioactive materials comprising:

a chamber (1) provided with a floor (2), a ceiling (3) and lateral walls (4,5),

a plurality of reception means (6) for receiving the irradiated fuel or the radioactive materials, these reception means (6) being arranged in the chamber in such a way as to be able to be submitted to the circulation of a cooling gaseous fluid,

means for introducing the gaseous fluid (24) into the chamber making it possible to introduce said cooling gaseous fluid,

means for evacuating gaseous fluid (25) outside the chamber to evacuate said cooling gaseous fluid after its circulation over the reception means,

means (8, 9, 19) making it possible to channel said cooling gaseous fluid towards a preferred circulation direction when it circulates over the reception means.

### CROSS-REFERENCE TO RELATED APPLICATION

This application claims priority based on International Patent Application No. PCT/FR01/02864, entitled “Storage Installation For Irradiated fuel Or Radioactive Materials” by Francois de Crecy, which claims priority of French application no. 00/11789, filed on Sep. 15, 2000, and which was not published in English.”

### TECHNICAL FIELD

The invention relates to medium or long-term storage of irradiated nuclear fuel or various types of radioactive materials. More precisely, it concerns storage installations for radioactive materials where the residual heat emitted by the fission reactions (radioactive decay) is evacuated by natural convection, mixed or forced and where a certain number of sub-systems (called shafts, packages or containers) containing these irradiated nuclear fuels or these various types of radioactive materials are set in the same chamber or cavity.

### STATE OF PRIOR ART

Installations for storage of irradiated fuel of nuclear materials exist, according to the following general principle. Sub-systems, usually metallic (for example “shafts” in these installations), containing the irradiated fuels or radioactive materials are arranged in a regular pattern in a chamber. This chamber has a horizontal floor and ceiling. The arrangement of the sub-systems is generally carried out according to a regular “layout”, for example square or triangular. An air-intake circuit, capable of comprising filters, anti-intrusion grids and a certain number of other devices assuring various functions, brings air from the outside into this chamber. The air thus brought in heats up in contact with the sub-systems and rises by natural or mixed convection, or is drawn by the movement of air as a whole. An air outlet circuit, able to comprise a chimney to encourage drawing or a ventilator and other devices to assure other functions, take the air from the chamber (preferably in general air from near the ceiling, since this is where the hot air accumulates) and ejects it outside.

These installations can operate in a satisfactory manner. However, they have a certain number of inconveniences. The air flow in the chamber is turbulent, multidimensional, very complex and difficult to predict. Since the ceiling of the chamber is horizontal, the hot air has a tendency to accumulate under the ceiling in the zones furthest away from the air outlet. Calculations have shown that the hottest points of the installation may be found close to the ceiling, far from the air outlet zone. This is due to the fact that, in order to be ejected from the outlet, the air benefits only from the buoyancy created just by the thickness gradient of the layer of hot air under the ceiling.

In the cases where the arrangement of the sub-systems allows it, preferred pathways for the air are formed in the zones of least resistance without any sub-system generating heat. This air bypassing the hot sub-systems lowers the performance of the installation since it “congests” the intake and outlet air circuits without contributing to cooling the sub-systems. This congestion results in a lowering of the air temperature in the chimney (and thus a reduction in the drawing, the flow drive), an unwanted overload and thus an expensive oversizing of the air intake and outlet circuits.

The thermal transients of the outside air (seasonal, daily or in certain weather conditions able to fall for a few minutes) are filtered by the thermal inertia of the walls and other devices of the air intake circuit. When air hotter than the intake circuit arrives, this results in a lowering of the air temperature between the outside and the intake to the chamber. The consequence of this lowering of temperature is a rise in the relative humidity of the air entering the chamber. This rise in relative humidity encourages condensation on the metallic structures of the cold parts of the sub-systems and on the other surfaces. This condensation raises the risks of corrosion and deterioration of the metallic structures of the cold parts of the sub-systems and on the other surfaces. This corrosion or deterioration can limit the lifetime of the installation. This phenomenon can be particularly disadvantageous since it is linked to the very complex structure of the flow and is thus difficult to predict in a reliable quantitative manner.

When the sub-system is arranged vertically or has a mainly vertical layout and when this sub-system gives out power, a thermal boundary layer of natural and mixed convection develops and can rise as far as the ceiling which it sweeps over. The lower superficial layer of the ceiling is thus heated to a temperature greater than the mixing temperature of the overall air flow. The thermal radiation coming from the shafts can also cause supplementary heating, especially if the surfaces have high emissivity. One or other of these phenomena, or the combination of the two, can lead to an excessively high temperature of the ceiling, requiring special and expensive precautions to avoid deterioration.

Thus there is the problem of overcoming the disadvantages mentioned above, which can be resumed as follows:

Low reliability of quantitative predictions for the flow within the chamber.

High temperature of the installation near the ceiling, far from the zone of the air outlet. Some air bypasses the sub-systems uselessly and congests the air intake and outlet circuits.

Thermal transients of the outside air can induce condensation, itself generating risks of corrosion or deterioration which are not very predictable.

The thermal boundary layer resulting from the sub-system, arranged vertically or in a mainly vertical direction under or near a ceiling, can heat the superficial layers below the ceiling to a temperature higher than the temperature of the mixture of the overall air flow.

The reduction of the consequences of these disadvantages must not compromise either the main functions of the installation (evacuation of the power given out, biological protection against ionising rays, long-term sustainability, ease of loading and unloading the fuel, possibility of surveillance and maintenance of the installation, etc.), or the advantages of this type of installation, among which can be mentioned:

The simplicity and the durability of operation.

The passivity, that is to say correct operation even without continuous surveillance.

The stability of operation.

The experience acquired thanks to existing installations.

The long-term correct operation: absence of mobile mechanical parts, use of a very simple physical principle, etc.

The ease of running the installation, disposal or removal of new irradiated fuels or radioactive materials.

This type of installation is intended for radioactive materials. Specific regulations and above all acceptance by the public impose the possibility of calculating in a credible manner its thermoaeraulic behaviour. A main constraint is thus the ability to demonstrate to which extent the calculations evaluating it are reliable and predictable. This constraint depends especially on the description of the thermoaeraulic operation complex of the installation and encourages research for solutions leading to more structured and predictable flows, even if they involve a slight complication of the system, or even a slight lowering of the thermal performance.

### DESCRIPTION OF THE INVENTION

In order to improve the predicted quality of the thermoaeraulic calculations in the chamber of the storage installation, it is suggested that the flow close to the sub-systems should be voluntarily structured by imposing a preferred direction for the air circulation. This preferred direction enables the modelling of thermoaeraulic flows of the air around the layout and consequently makes the results more reliable quantitatively.

The aim of the invention is a storage installation for irradiated fuel or radioactive materials comprising:

a chamber provided with a floor, a ceiling and lateral walls,

a plurality of reception means for receiving the irradiated fuel or the radioactive materials, these reception means being arranged in the chamber in such a way as to make it possible to be submitted to the circulation of a cooling gaseous fluid,

means for introducing gaseous fluid into the chamber making it possible to introduce said cooling gaseous fluid,

means for evacuating gaseous fluid outside the chamber in order to evacuate said cooling gaseous fluid after its circulation over the reception means,

means making it possible to channel said cooling gaseous fluid in order to impart it with a preferred circulation direction when it circulates over the reception means, the installation being characterised in that the means making it possible to channel the cooling gaseous fluid comprise:

sleeves surrounding the reception means leaving a space between them and the reception means for the circulation of the cooling gaseous fluid, these sleeves having intake and outlet openings to ensure the circulation of the cooling gaseous fluid,

partitions linking the sleeves, these partitions being arranged according to a direction corresponding to the preferred direction for circulation of the cooling gaseous fluid.

Advantageously, the reception means close to the lateral walls of the chamber are arranged as close as possible to these lateral walls in order to avoid the cooling gaseous fluid forming bypass currents. This can be achieved by arranging the reception means (or sub-systems) according to a regular layout going right up to the walls by minimising the distance between the lateral wall and adjacent sub-systems.

The sleeves can also constitute radiating screens.

The presence of partitions linking the sleeves, these partitions being arranged according to a direction corresponding to the preferred direction for circulation of the cooling gaseous fluid, results in further improvement of the structuring of the flow of the cooling gaseous fluid.

The means making it possible to channel the cooling gaseous fluid can also comprise partitions linking at least one lateral wall of the chamber to sleeves neighbouring this lateral wall, these partitions being arranged according to a direction corresponding to the preferred direction for circulation of the cooling gaseous fluid. This contributes to further improvement of the structuring of the gaseous flow.

The installation can furthermore comprise supplementary means making it possible to channel said cooling gaseous fluid, these supplementary means being located between a lateral wall of the chamber and one or several sleeves and being arranged according to a direction corresponding to the preferred direction for circulation of the cooling gaseous fluid. These supplementary means make it possible to reduce the bypass currents when the sub-systems are arranged according to special layouts, for example according to a triangular layout.

Preferably, if the means of evacuation of the gaseous fluid are located in the ceiling or close to the ceiling, the ceiling is inclined and the means for evacuation of the gaseous fluid are located in the highest part of the chamber. This results in a reduction of the maximum temperature of the gaseous fluid near the ceiling, far from the outlet zone of the gaseous fluid. The angle of inclination of the ceiling can be comprised between 10° and 20° relative to the horizontal. Preferably, this angle is equal to 15°. This inclination allows the hot gas to be released more easily thanks to buoyancy forces, avoids its accumulation in these zones and thus avoids the creation of hot spots.

The chamber can also be provided with an inclined floor rising towards the means for evacuating the gaseous fluid. This further improves the thermoaeraulic behaviour. An advantage of this solution is to leave a greater cross-section for passage of the gaseous fluid at the intake than at the outlet. Thus one encourages a more even rate of gas flow to feed the various subsystems and to ensure more homogeneous provision of cool gaseous fluid for the sub-systems as a whole.

The installation can furthermore comprise a branch line for cooling gaseous fluid to recycle part of the cooling gaseous fluid, having circulated in the chamber or being in thermal contact with the chamber. This part of recycled cooling gaseous fluid can be carried out in an evacuation chimney communicating with the means of gaseous fluid evacuation. Thus it is possible to avoid temperature transients of the gaseous fluid (the air, for example) producing condensation which can generate risks of corrosion or deterioration which are difficult to predict. Part of the reheated gaseous fluid leaving the storage chamber is reintroduced into the intake circuit, preferably as close as possible to the storage chamber in order to raise the temperature of the gas entering the chamber and thus to reduce the relative humidity.

Adjustable elements for load losses can be set in the branch line or in the means for evacuating gaseous fluid, in order to control the quantity of cooling gaseous fluid recycled.

Thermal radiating plates can be associated with the reception means, these plates being located close to the ceiling in order to de-structure the thermal boundary layer at the ceiling surface. Thus it is possible to avoid the thermal boundary layer resulting from a sub-system, arranged vertically or in a mainly vertical direction under or close to the ceiling, being able to heat the superficial layers under the ceiling to a temperature higher than the temperature of the mixture of the overall flow of gaseous fluid. In fact, these plates play a double role. By destabilising the thermal boundary layer, they provoke a mixture of the gaseous fluid and lower its temperature. They also act as radiating screens, protecting the ceiling, at least partially, from the thermal radiation issuing from the means of reception.

### BRIEF DESCRIPTION OF THE DRAWINGS

The invention will be better understood and other advantages and particularities will become apparent when reading the following description, given as a non-limiting example, accompanied by the attached drawings among which:

FIG. 1 is a vertical cross-section of a storage installation for irradiated fuel or radioactive materials, according to the present invention,

FIG. 2 is a transversal cross-section of part of the storage installation for irradiated fuel or radioactive materials shown in FIG. 1,

FIG. 3 is a transversal cross-section of a part of another storage installation for irradiated fuel or radioactive materials, according to the present invention.

### DETAILED DESCRIPTION OF EMBODIMENTS OF THE INVENTION

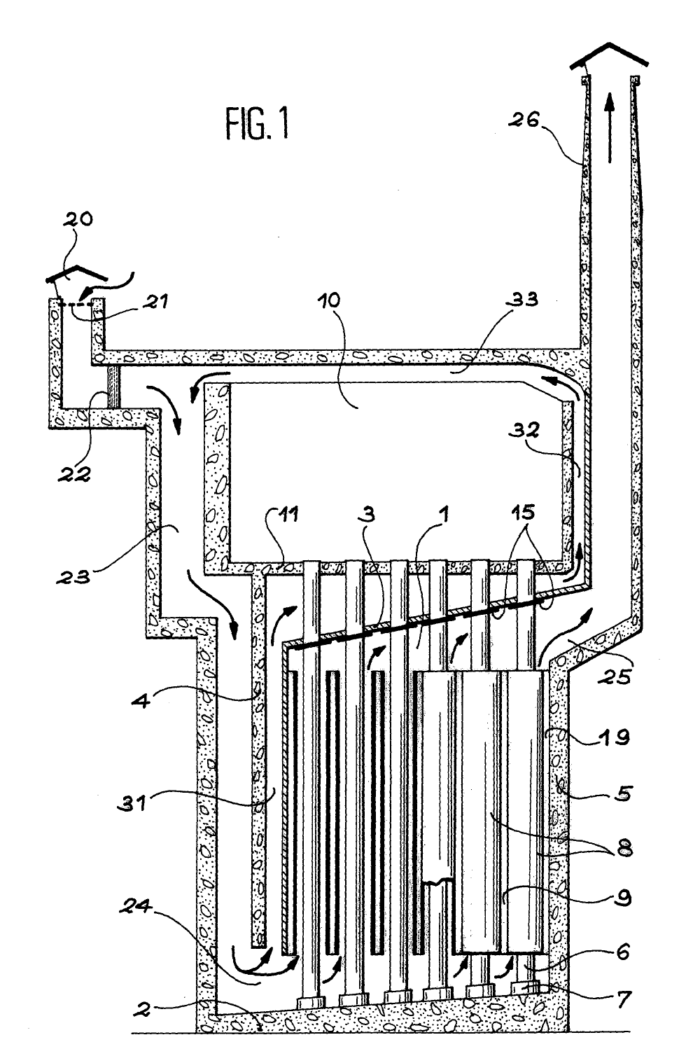

FIG. 1 is a vertical cross-section of a storage installation for irradiated fuel or radioactive materials, according to the present invention.

The installation comprises a chamber 1, buried in the example shown and provided with a floor 2, a ceiling 3 and lateral walls of which only two, walls 4 and 5, are visible. In the chamber 1 a plurality of reception means or shafts 6 are arranged.

The shafts 6 are, in the example of FIG. 1, tubular elements suspended from the floor 11 of the handling chamber 10 to be found above the chamber 1. The foot of each shaft 6 can travel within a snubber 7 through the intermediary of dampers, not shown. The irradiated fuel or the radioactive materials are arranged in the shaft from the handling chamber 10 according to conditioning processes known to those skilled in the art.

The shafts 6 are each surrounded, in the heating part of the shafts, by a sleeve 8 which has a multiple role: radiating screen, chimney, flow structuring. The sleeves 8 surround the shafts 6 in order to leave an annular space between the shaft and corresponding sleeve, sufficient to allow correct cooling of the shafts. As an example, for a shaft of 90 cm diameter, the corresponding sleeve can be of 140 cm in diameter.

Partitions 9 link the sleeves 8 together. They do not play a direct thermal role but help to structure the flow of cooling gaseous fluid vertically and to avoid transverse currents in general. Other partitions, reference 19, also link the sleeves 8 located close to the lateral walls (for example wall 5) to these lateral walls, to both structure the flow and to avoid bypass currents. The sleeves 8 rest on the floor 2 with supports not shown and which do not disturb the circulation of the cooling gaseous fluid. The presence of partitions 9 and 19 also ensures greater stability of the sleeves as a whole.

The storage installation shown in FIG. 1 is air-cooled. Cool air penetrates through the aeration mouth 20, passes through a grid 21 and an electrostatic filter 22 and is led along a conduit 23 to the air intake 24 of the chamber 1. Advantageously, the intake is located in the lowest part of the chamber 1. In the same way, the air outlet 25 is advantageously located in the highest part of the chamber 1. It communicates with an evacuation chimney 26. Between the air intake 24 and the air outlet 25, the cooling air is thus channelled in a vertical direction by the sleeves 8 and the partitions 9 and 19.

FIG. 1 shows that the floor 2 and the ceiling 3 are inclined in order to facilitate air circulation. The floor 2 and the ceiling 3 rise towards the air outlet 25.

The ceiling 3 can be made of sheet metal. Near the ceiling 3, the thermal boundary layer is de-constructed by plates 15 also playing the role of radiating screens. Advantageously, these plates can be arranged several centimetres beneath the ceiling in order that their two faces can be in contact with the cooling fluid so that the heat exchange takes place through these two faces.

The installation shown in FIG. 1 further comprises a branch air circuit. This supplementary air circuit, under natural convection, comprises a first vertical duct 31 bringing air between the ceiling 3 and the floor 11 of the handling chamber 10. The reheated air then circulates in the second vertical duct 32 and then in a horizontal duct 33, to return to the duct 23. The branch air circuit sends lukewarm air back to the entrance to the chamber 1, which raises the temperature of the air slightly at the entrance and reduces the risks of condensation. Another possible embodiment consists of extracting air directly from the outlet chimney.

This air recirculation must raise the air temperature at the entrance moderately, typically by a few degrees. The proportion of air circulating must be low at full power and rise when the power diminishes, to tend towards a proportion of 100% at zero power. In order to satisfy this condition, it is necessary to envisage adjustable load loss elements in the branch circuit or the air outlet circuit or in the two circuits. The adjustment of these elements could take place after each loading or unloading of nuclear materials, to take into account the new power being stored, or when the power stored has decreased significantly (normal radioactive decay). The latter case can involve a period from several years to several tens of years between two consecutive adjustments.

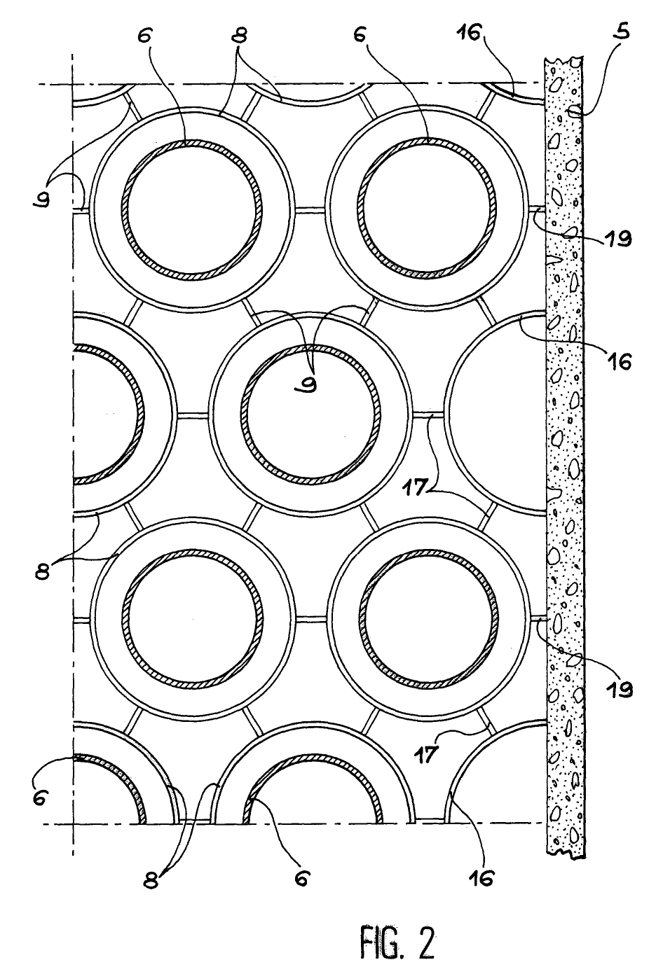

FIG. 2 is a transversal cross-section of part of the installation shown in vertical cross-section in FIG. 1. The shafts 6 can be seen, arranged according to a regular triangular layout, the sleeves 8, the partitions 9 between sleeves and the partitions 19 linking the partitions 9 to the lateral wall 5. The shafts 6 surrounded by their sleeves 8 are arranged as close as possible to the lateral walls to avoid the presence of bypass currents. Elements 16 or “mannequins”, equivalent to half-sleeves (in the longitudinal direction) are present against the lateral wall 5 and are linked to the closest sleeves by partitions 17. This arrangement makes it possible to structure the air flow, such that the shafts located close to the lateral wall 5 are submitted to the same type of flow and so that bypass currents are avoided.

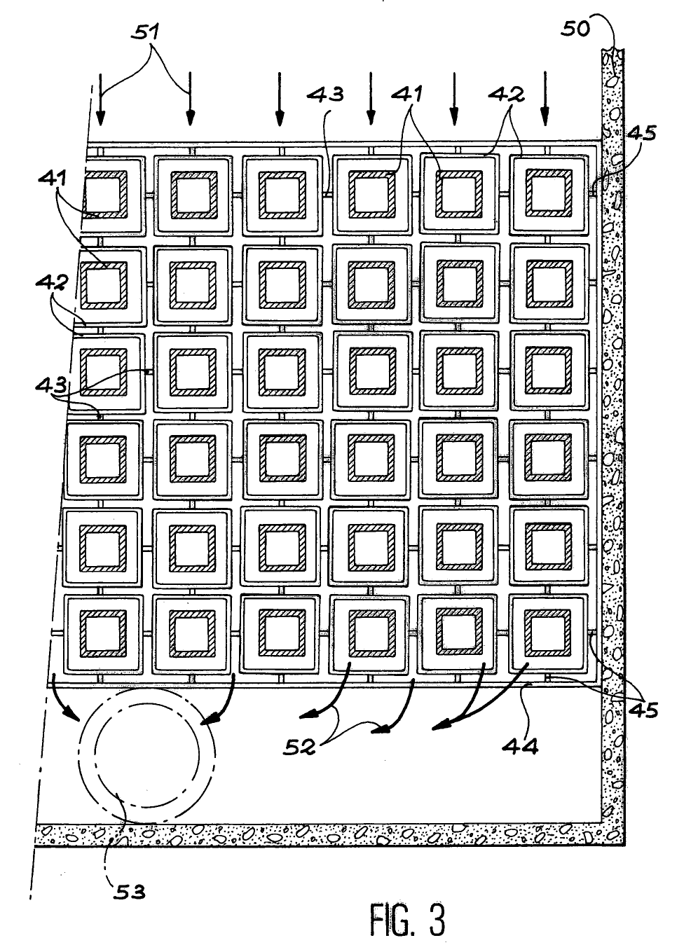

FIG. 3 is a transversal cross-section seen from above of part of another storage installation for irradiated fuel or radioactive materials. This installation differs from the above installation because of the shape of the shafts. The shafts 41 of this variant have a square cross-section. The sleeves 42 surrounding them also have a square cross-section. They are linked together by partitions 43.

This configuration of shafts 41 makes it possible to arrange them according to a regular square layout which extends as closely as possible to the lateral wall 50 in order to avoid bypass currents. The sleeves as a whole can be surrounded by an envelope 44 linked to the adjacent sleeves by partitions 45 in order to further raise the structuring of the flow and to reduce the bypass currents.

The arrows 51 represent the air at ground level which will penetrate from the bottom into the network of sleeves and partitions. The arrows 52 represent the air exiting from the network of sleeves and partitions, under the ceiling and moving towards the air outlet represented symbolically as 53.

Thus the invention makes it possible to provide a better structuring of flows, thus better reliability of the calculations describing them. This implies that demonstrations of security of correct operation and the procedures for certification will be easier. Acceptance by the public should thus be greater.

The invention makes it possible to reduce the maximum temperatures of the storage. In particular, it makes it possible to reduce the maximum temperatures to which the lateral walls are submitted and in particular the ceiling.

The invention also makes it possible to reduce the unwanted bypass flow round the shafts. Thus it makes it possible to dimension the air intake and outlet circuits more economically while still ensuring homogeneous and efficient cooling.

The invention also makes it possible to reduce the quantities of water resulting from the humidity of the outside air condensing on the cold parts of the installation.

By enabling the temperature on the surface of the ceiling of the storage chamber to be lowered, the design of this ceiling, its production, its qualification and its certification are thus simplified.

1. Storage installation for irradiated fuel or radioactive materials comprising:
a chamber provided with a floor, a ceiling and lateral walls,
a plurality of reception means for receiving the irradiated fuel or the radioactive materials, these reception means being arranged in the chamber in such a way as to enable them to be submitted to the circulation of a cooling gaseous fluid,
means for introducing gaseous fluid into the chamber making it possible to introduce said cooling gaseous fluid,
means for evacuating gaseous fluid outside the chamber in order to evacuate said cooling gaseous fluid after its circulation over the reception means,
means making it possible to channel said cooling gaseous fluid in order to impart it with a preferred circulation direction when it circulates over the reception means, the installation being characterised in that the means making it possible to channel the cooling gaseous fluid comprise:
sleeves surrounding the reception means leaving a space between them and the reception means for the circulation of the cooling gaseous fluid, these sleeves having intake and outlet openings to ensure the circulation of the cooling gaseous fluid,
partitions linking the sleeves, these partitions being arranged according to a direction corresponding to the preferred direction for circulation of the cooling gaseous fluid.

2. Installation according to claim 1, wherein the reception means next to the lateral walls of the chamber are arranged as close as possible to these lateral walls in order to avoid the cooling gaseous fluid forming bypass currents.

3. Installation according to claim 1, wherein the sleeves also constitute radiating screens.

4. Installation according to claim 1, wherein the means making it possible to channel the cooling gaseous fluid also comprise partitions linking at least one lateral wall of the chamber to the sleeves next to this lateral wall, these partitions being arranged according to a direction corresponding to the preferred direction for circulation of the cooling gaseous fluid.

5. Installation according to claim 1, wherein it further comprises supplementary means making it possible to channel said cooling gaseous fluid, these supplementary means being located between one lateral wall of the chamber and one or several sleeves and being arranged according to a direction corresponding to the preferred direction for circulation of the cooling gaseous fluid.

6. Installation according to claim 1, wherein the means for evacuating the gaseous fluid being located at the ceiling or close to the ceiling, the ceiling is inclined and the means of evacuation of the gaseous fluid are located in the highest part of the chamber.

7. Installation according to claim 6, wherein the ceiling is inclined at an angle comprised between 10° and 20° relative to the horizontal.

8. Installation according to claim 1, wherein the chamber is provided with an inclined floor rising towards the means for evacuation of the gaseous fluid.

9. Installation according to claim 1, wherein it further comprises a branch circuit for the cooling gaseous fluid to recycle part of the cooling gaseous fluid having circulated in the chamber or having been in thermal contact with the chamber.

10. Installation according to claim 9, wherein the part of the cooling gaseous fluid recycled is extracted in an evacuation chimney communicating with the means of evacuation of the gaseous fluid.

11. Installation according to claim 9, wherein adjustable load loss elements are envisaged in the branch circuit or in the evacuation means for gaseous fluid, to control the quantity of cooling gaseous fluid recycled.

12. Installation according to claim 1, wherein the thermal radiating plates are associated with the reception means, these plates being located close to the ceiling to de-structure the thermal boundary layer at the surface of the ceiling.

13. Installation according to claim 1, wherein the cooling gaseous fluid is air.
